(19) United States
(12) Patent Application Publication
(10) Pub. No.: US 2004/0235492 A1
(43) Pub. Date: Nov. 25, 2004

(54) Apprising system for use with a cellular telephone and a method of operation thereof

(75) Inventors: Yuh Jye Chang, Bridgewater, NJ (US); Harsha S. Nagesh, New Providence, NJ (US); Vishwanath Poosala, Basking Ridge, NJ (US); Anurag Srivastava, Roselle, NJ (US)

Correspondence Address: HITT GAINES P.C., P.O. BOX 832570, RICHARDSON, TX, 75083, US

(73) Assignee: Lucent Technologies, Inc., Murray Hill, NJ

(21) Appl. No.: 10/442,775

(22) Filed: May 21, 2003

(51) Int. Cl. H04Q 7/20

(52) U.S. Cl. 455/456.1; 455/456.2; 455/422.1

(57) ABSTRACT

An apprising system and a method of apprising are set forth for use with a cellular telephone to apprise a user of the cellular telephone of a spontaneous occurrence. In one embodiment, the apprising system includes: (1) a matching subsystem that compares a location of the cellular telephone to an area associated with an occurrence and (2) an informing subsystem that notifies a user of the cellular telephone of the occurrence based on the compares.

### TECHNICAL FIELD OF THE INVENTION

The present invention is directed, in general, to cellular communications and, more specifically, to an apprising system that employs a cellular telephone and a method of operation thereof.

### BACKGROUND OF THE INVENTION

The use of wireless communication continues to expand. The growth of wireless communications networks has provided an alternative to communicating through traditional wired telephone networks. In addition to the continued growth, the wireless communications networks continue to improve in quality encouraging even more people to use wireless technology to meet their communications needs.

Cellular telephones also continue to improve in quality. Presently, cellular telephones may consistently provide communications comparable to traditional wired telephones even over long distance. In fact, cellular telephones are often the desired device for long distance communication due to beneficial long distance calling plans.

Along with improvements in quality, the uses of cellular telephones are expanding. Cellular telephones are now often being used for more than voice communication. For example, Short Messaging Service (SMS) is a popular text messaging tool commonly used for communicating by cellular telephone users. SMS provides a type of instant messaging for users via their cellular telephones instead of via their computers using the Internet.

In addition to SMS, cellular telephones may be used to exchange other types of data. For example, some cellular telephones may be used to receive stock quotes, sporting event updates and weather reports. Certain cellular telephones are even equipped to take pictures and send them to a friend. While the uses of cellular telephones continue to increase, more people are able to communicate and receive data while mobile.

Another feature associated with wireless communication networks provides an accurate location of cellular telephones. Determining an accurate location of a cellular telephone has become mandatory for emergency services like 911. The Federal Communication Commission (FCC) has developed and initiative, Enhanced 911, to provide accurate mobile locations for 911 calls. For handset based locating techniques, Enhanced 911 requires a location within 50 meters for 67% of telephone calls and within 150 meters for 95% of telephone calls. For network based techniques, Enhanced 911 requires a location within 100 meters for 67% of calls and within 300 meters for 95% of calls. The European Union has a similar initiative entitle E-112. Though these type of initiatives may generate additional revenue for location based services, wireless telecommunications systems do not adequately employ the locating services and the ability to receive data of cellular telephones to provide location information a mobile user.

Accordingly, what is needed in the art is a system and method that provides location based information to a user of a cellular telephone.

### SUMMARY OF THE INVENTION

To address the above-discussed deficiencies of the prior art, the present invention provides, for use with a cellular telephone, an apprising system for spontaneous occurrences and a method of apprising. In one embodiment, the apprising system includes: (1) a matching subsystem that compares a location of the cellular telephone to an area associated with an occurrence and (2) an informing subsystem that notifies a user of the cellular telephone of the occurrence based on the compares.

The present invention, therefore, advantageously employs a cellular telephone to apprise a user thereof of a spontaneous occurrence. A spontaneous occurrence may be a happening or event that is unanticipated by the user. The spontaneous occurrence may be subjectively spontaneous to the user. In other words, the spontaneous occurrence may be an unanticipated or unplanned event to the user but anticipated by participants involved in the event. For example, an organized protest or march may not be spontaneous to the participants of the protest but may be spontaneous to the user. Some spontaneous occurrences, such as a tornado, may be spontaneous to more people than just the user.

Unlike existing alerting systems, the present invention provides a non-obtrusive way to apprise the user of an occurrence of interest by employing a cellular telephone. Existing alerting systems may require the user to wear a specialized hardware gadget or sensor designed to detect and inform the user when emergency actions are needed. For example, the user may wear a sensor to indicate anthrax exposure. These systems, however, require the user to wear a device that is typically limited to a particular danger. Instead of wearing an additional device with limited capabilities, the present invention may allow the user to employ the cellular telephone to avoid the area associated with the occurrence or react with knowledge of the occurrence.

In another aspect, the present invention provides a method of apprising a user of a cellular telephone of a spontaneous occurrence. The method of apprising includes: (1) comparing a location of the cellular telephone to an area associated with an occurrence and (2) notifying the user of the occurrence based on the comparing.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of an embodiment of an apprising system for spontaneous occurrences constructed in accordance with the principles of the present invention; and

FIG. 2 illustrates a flow diagram of an embodiment of a method of apprising a user of a cellular telephone of a spontaneous occurrence constructed according to the principles of the present invention.

### DETAILED DESCRIPTION

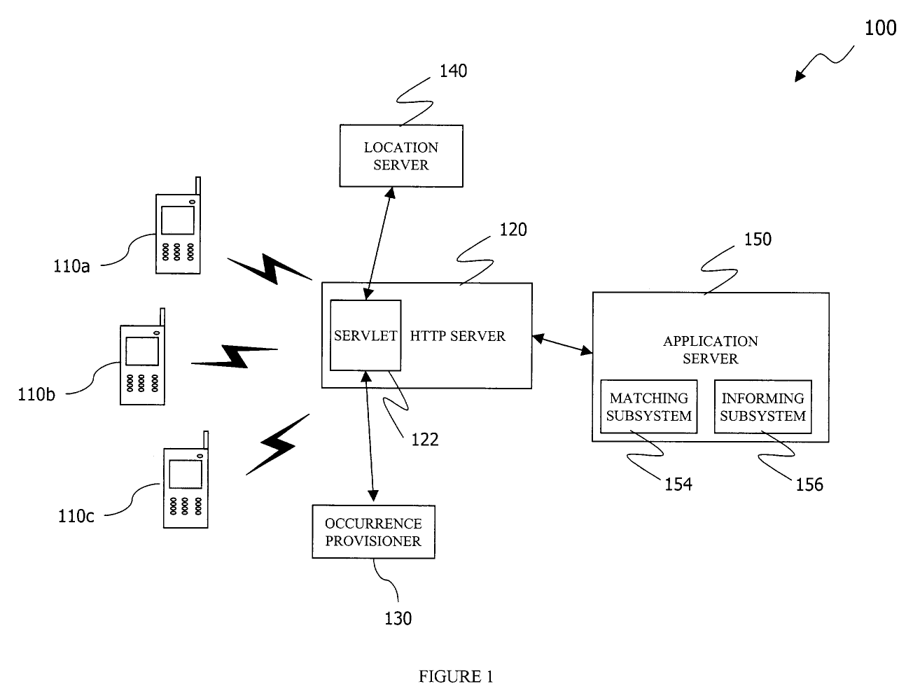

Referring initially to FIG. 1, is a system diagram of an embodiment of an apprising system for spontaneous occurrences, generally designated 100, constructed in accordance with the principles of the present invention. The apprising system 100 includes cellular telephones 110a, 110b, 110c, (collectively referred to as a plurality of cellular telephones 100), a webserver 120, an occurrence provisioner 130, a location server 140, and an application server 150. The webserver 120 includes a servlet 122 and the application server 150 includes a matching subsystem 154 and an informing subsystem 156.

The apprising system 100 may include components commonly used within a cellular communications network. The apprising system 100 may be used to inform people of an occurrence or of multiple occurrences that are, for example, potentially dangerous, a cause of inconvenience or of particular interest. The occurrences may be spontaneous occurrences such as a traffic disturbance, a civil disturbance, a weather disturbance or a crime. Additionally, the occurrence may be a contaminating event such as a delivery of an anthrax agent by a terrorist organization or the discovery of a contagious virus in a certain geographic area. Of course, one skilled in the art will understand that there are other occurrences in addition to the ones mentioned above in which the user may be notified.

The plurality of cellular telephones 110 may include components commonly employed within conventional cellular telephones. Each of the plurality of cellular telephones 110 may be equivalent. Of course, in other embodiments, the plurality of cellular telephones 110 may differ, for example, in manufacturer, size, power, etc. The plurality of cellular telephones 110 may operate in various cellular telecommunication networks. In some embodiments, the plurality of cellular telephones 110 may operate in a Groupe Spéciale Mobile (GSM) system while in other embodiments, a Code Division Multiple Access (CDMA) system. For ease of discussion, the cellular telephone 110a may be used to represent the plurality of cellular telephones 110 in portions of the discussion regarding FIG. 1.

The cellular telephone 110a may include a front end client or midlet that provides an interface with the webserver 120 through the servlet 122. The midlet may be a sequence of operating instructions that is downloaded to the cellular telephone 110a from the webserver 120. The midlet may be an application that conforms to a Mobile Information Device Profile (MIDP) standard that defines how applications interface with cellular phones. The midlet may be written using an application program interface (API) such as Java 2 Platform Micro Edition (J2ME), provided by Sun Microsystem,™ to provide ease of porting to the plurality of cellular telephones 110. Of course, one skilled in the art will understand that the midlet may be written using specific APIs associated with particular cellular telephones. The midlets may use cookies to ensure that multiple connections can make use of the state of the user stored in the servlet 122.

The webserver 120 may be a Hypertext Transfer Protocol (HTTP) server that facilitates a protocol transfer of hypertext-based files between local and remote systems. For example, the webserver 120 may facilitate the transfer of hypertext-based files between the application server 150 and the cellular telephone 110a, the occurrence provisioner 130 and the location server 140.

The servlet 122 may be a sequence of operating instructions such as a Java applet. Typically, the servlet 122 is persistent allowing processing of multiple requests from, for instance, the cellular telephone 110a, the occurrence provisioner 130 and the location server 140. The servlet 122 may periodically remove profiles of users who are not presently active to provide good memory management and scalability of the apprising system 100 to a large number of users.

The occurrence provisioner 130 may be a web application providing a mechanism to enter information into the apprising system 100. For example, the occurrence provisioner 130 may be a government entity that maintains a data base having a map with the location of a contaminating event such as an anthrax exposure. The occurrence provisioner 130 may send information of a geographically defined area associated with the contaminating event to the webserver 120 via the servlet 122. The information may be sent via a web form coupled with the servlet 122. One skilled in the art will understand that the occurrence provisioner 130 may also provide traffic information, weather information, crime reports, etc. Additionally, one skilled in the art will understand that more than one occurrence provisioner may by employed.

The location server 140 may provide a location of the cellular telephone 110a. The location server 140 may be a third party that provides location information for the apprising system 100. In a preferred embodiment, the location server 140 may be an Intelligent Services Gateway from Lucent Technologies, Inc., that provides a gateway to a wireless network and provides the location of the user.

In response to a query from the servlet 122, the location server 140 may send the location to the webserver 120 via the servlet 122 for further processing by the application server 150. The location server 140 may determine the location of the cellular telephone 110a through a cellular telephone positioning system. The cellular telephone positioning system may be a network based system that employs triangulation. For example, a GSM telecommunications network may use enhanced observed time difference of arrival (E-OTDA) and a CDMA telecommunications network may use advanced forward link triangulation (AFLT). Instead of a network based system, the location of the cellular telephone 110a may be determined through a handset based system such as a Global Positioning System (GPS) or an Assisted GPS (AGPS).

The application server 150 may be a backend application server written in java and loaded on a workstation. Preferably, the application server 150 is multi-threaded and maintains a state of the apprising system 100. The state of the apprising system 100 may be periodically check-pointed to recover data when the application server 150 may be shut down, such as, for maintenance. The application server 150 may maintain a database to insure that users are unique and can register with a cellular telephone number is not registered in the apprising system 100. All events provided by the occurrence provisioner 130 could be retrieved from the database for viewing. The application server includes the matching subsystem 154 and the informing subsystem 156.

The matching subsystem 154 may be a sequence of operating instructions configured to compare the location of the cellular telephone 110a to an area associated with an occurrence. The matching subsystem 154 may compare the location of the cellular telephone 110a acquired through a query of the servlet 122 to a geographically defined area associated with an occurrence obtained from the occurrence provisioner 130. Coordinates of the location may be compared to coordinates of the geographically defined area to determine if the location is within the geographically defined area and, therefore, coincide. Alternatively, coordinates associated with the occurrence may be compared to coordinates of the location to determine if the occurrence is proximate the location. An occurrence may be proximate if within a tracking distance of the location. A match may be obtained by the matching subsystem 154 when the location and the area coincide or are proximate. In some embodiments, the location may be based on the last known location of the user when, for example, the user is not presently trackable.

The matching subsystem 154 may compare the location with occurrences within a radius of the tracking distance. The tracking distance may be a defined distance that the user selects to establish a radius for apprising of a particular occurrence or for all occurrences. The tracking distance may be user defined and changed as appropriate. For example, the user may start with a tracking distance between a range of three to ten miles and alter the range when appropriate. The tracking distance may be dynamically defined by the user employing the cellular telephone 110a. In other embodiments, the tracking distance may be preset when the user registers with the apprising system 100. A higher cost for using the apprising system 100 may be associated with a smaller tracking distance which could result in a detailed mapping notification. Additionally, the user may track occurrences continually or selectively enable and disable tracking.

The user may also define a trackable distance that specifies a distance in which the user may be tracked. The user may also selectively enable and disable the trackable distance. Selectable tracking and trackable distances may provide flexibility and levels of privacy for the user.

The informing subsystem 156, coupled to the matching subsystem 154, may be a sequence of operating instructions configured to notify a user of the cellular telephone 110a of an occurrence based on the comparing performed by the matching subsystem 154. In some embodiments, the informing subsystem 156 may notify the user when the user's location is within the tracking distance of the area associated with the occurrence. The informing subsystem 156 may notify the user via the cellular telephone 110a employing several different modes or signals. For example, the informing subsystem 156 may notify the user employing a visual signal, an audible signal, a vibratory signal or a combination thereof. In some embodiments, the informing subsystem 156 may employ a map on a display of the cellular telephone 110a to notify the user of an occurrence. The map may be a real-time map down loaded via the servlet 122 to the cellular telephone 110a from a map server, such as MapsOnUs®, coupled to the webserver 120. The map may illustrate a location of the user relative to a spontaneous occurrence.

The informing subsystem 156 may dynamically notify the user upon the matching subsystem 154 obtaining a match. In other embodiments, the user may be notified a designated time period after the match has been obtained. For example, the informing system 156 may notify the user of exposure to a contaminating event the following day.

In some embodiments, the user may be notified before an actual match is obtained. In other words, the matching subsystem 154 may determine a potential match and the informing subsystem 156 may notify the user. The potential match may be based, for example, on established patterns, such a particular route to work, or on a predicted route based on the present location and movement of the user.

After being notified, the user may act based on notification. For example, the user may avoid the area associated with the occurrence. Alternatively, the user may call or send a text message to an entity associated with the occurrence. Of course one skilled in the art will understand that the user may initiate calls or text messages to multiple entities according to the notification.

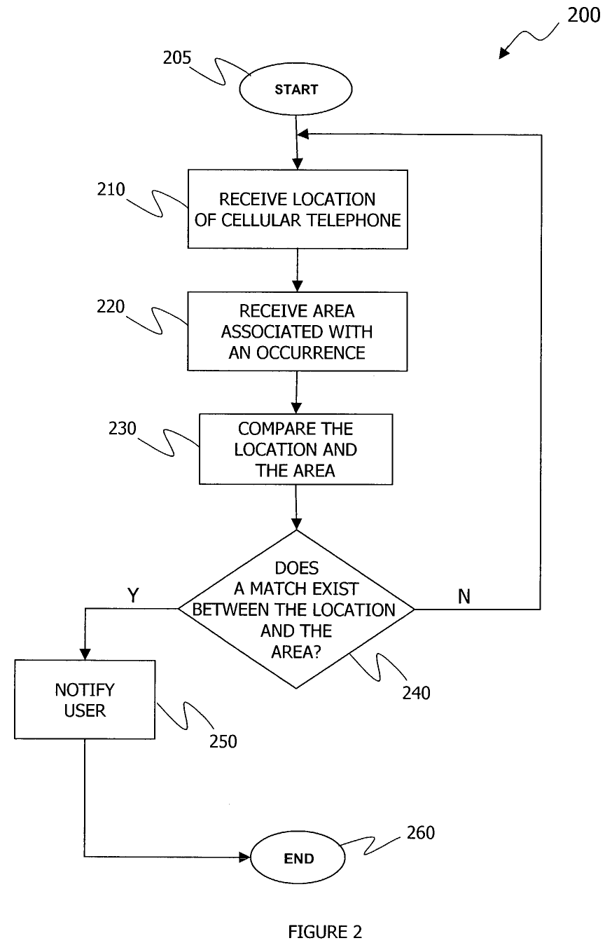

Turning now to FIG. 2, illustrated is a flow diagram of an embodiment of a method of apprising a user of a cellular telephone of a spontaneous occurrence, generally designated 200, constructed according to the principles of the present invention. The method starts in a step 205 with an intent to apprise a user.

After starting, a location of a cellular telephone is received in a step 210. The location may be received by a webserver as a result of a query from a servlet. The location may be determined by a cellular telephone positioning system. The cellular telephone may be a cellular telephone of the user.

After receiving the location, an area associated with an occurrence is received in a step 220. The area may be a geographical area defined by coordinates of longitude and latitude. The area may be provided to the webserver through the servlet employing a web form having information defining the area. The area may be received from an occurrence provisioner coupled to the webserver via the Internet. The occurrence may be, for example, a contaminating event, a traffic disturbance, a civil disturbance, a weather disturbance or a crime.

After receiving the area of the occurrence, the location and the area are compared in a step 230. The location may be the present location of the cellular telephone. The location and the area may be compared by employing a data table of an application server coupled to the webserver. More specifically, data associated with the location and the area may be obtained via a look-up table for comparison.

After comparing, a determination is made if a match exist between the occurrence and the location in a decisional step 240. A match may exist if the location is within the area associated with the occurrence. A match may also exist if the area associated with the occurrence is within a tracking distance of the location. In some embodiments, a potential match may occur.

If a match occurs, the user is notified in a step 250. The user may be notified dynamically. The user may be notified employing the cellular telephone through several signals such as a visual signal, an auditory signal, a vibratory signal or a combination thereof. In some embodiments, the user may be notified employing a map on the display of the cellular telephone. Additionally, an other person may be notified of a match. For example, a parent of the user. In alternative embodiments, the other person may be notified instead of the user based on the type of occurrence or based on the user.

After notifying, the method ends in a step 260. Returning now to decisional step 240, if a match does not occur, then the method for apprising a user of a cellular telephone of a spontaneous occurrence returns to step 210 and continues as described above.

While the method disclosed herein has been described and shown with reference to particular steps performed in a particular order, it will be understood that these steps may be combined, subdivided or reordered to form an equivalent method without departing from the teachings of the present invention. Accordingly, unless specifically indicated herein, the order and/or the grouping of the steps are not limitations of the present invention.

The present invention provides an apprising system and an apprising method for notifying a user of a cellular telephone of spontaneous occurrences based on a location of the cellular telephone and the occurrences. The apprising system may be a three tiered system having a sequence of operating instructions within the cellular telephone, a webserver and an application server. This beneficial enhancement to cellular telephone users may also be used with pagers, personal digital assistants, laptop computers, or other wireless communications devices to provide location based information.

The present invention may be beneficial to others in addition to the user. The location based information may be used to send instructions or memos to users who are within a defined geographical area. Additionally, the application server of the apprising system may include a database that provides numerical data that is location based. The numerical data may be employed by a third party to determine a traffic flow of people within a certain geographic area and within a certain time period. The present invention may also provide the location based information to disable cellular telephone within certain areas associated with hospitals, movie theaters, etc. Furthermore, the present invention may be used by military or police for tracking of personnel during operations.

Although the present invention has been described in detail, those skilled in the art should understand that they can make various changes, substitutions and alterations herein without departing from the spirit and scope of the invention in its broadest form.

What is claimed is:

1. For use with a cellular telephone, an apprising system for spontaneous occurrences, comprising:
a matching subsystem that compares a location of said cellular telephone to an area associated with an occurrence; and
an informing subsystem that notifies a user of said cellular telephone of said occurrence based on said compares.

2. The apprising system as recited in claim 1 wherein said occurrence is selected from the group consisting of:
a contaminating event,
a traffic disturbance,
a civil disturbance,
a weather disturbance, and
a crime.

3. The apprising system as recited in claim 1 wherein said location is provided by a cellular telephone positioning system.

4. The apprising system as recited in claim 1 wherein said user selectively disables monitoring of said location.

5. The apprising system as recited in claim 1 wherein said matching system performs said comparing based on a present location of said user.

6. The apprising system as recited in claim 1 wherein said informing subsystem notifies an entity of said occurrence based on said compares.

7. The apprising system as recited in claim 1 wherein said informing subsystem performs said notifies when said location is within a tracking distance of said area.

8. The apprising system as recited in claim 1 wherein said informing subsystem employs a signal for said notifies selected from the group consisting of:
a visual signal,
an audible signal,
a vibratory signal, and
a combination including any two of a visual signal, an audible signal and a vibratory signal.

9. The apprising system as recited in claim 1 wherein said informing subsystem employs a map on a display of said cellular telephone.

10. The apprising system as recited in claim 1 wherein said informing subsystem performs said notifies dynamically.

11. A method of apprising a user of a cellular telephone of a spontaneous occurrence, comprising:
comparing a location of said cellular telephone to an area associated with an occurrence; and
notifying said user of said occurrence based on said comparing.

12. The method as recited in claim 11 wherein said occurrence is selected from the group consisting of:
a contaminating event,
a traffic disturbance,
a civil disturbance,
a weather disturbance, and
a crime.

13. The method as recited in claim 11 further comprising providing said location through a cellular telephone positioning system.

14. The method as recited in claim 11 wherein said user selectively disables monitoring of said location.

15. The method as recited in claim 11 wherein said comparing is based on a present location of said cellular telephone.

16. The method as recited in claim 11 further comprising notifying an entity of said occurrence based on said comparing.

17. The method as recited in claim 11 wherein said notifying is performed when said location is within a tracking distance of said area.

18. The method as recited in claim 11 wherein said notifying employs a signal selected from the group consisting of:
a visual signal,
an audible signal,
a vibratory signal, and
a combination including any two of a visual signal, an audible signal and a vibratory signal.

19. The method as recited in claim 11 wherein said notifying employs a map on a display of said cellular telephone.

20. The method as recited in claim 11 wherein said notifying is dynamic.
